(19) United States
(12) Patent Application Publication
(10) Pub. No.: US 2024/0295679 A1
(43) Pub. Date: Sep. 5, 2024

(54) OPTICAL MEMBER AND OPTICAL APPARATUS

(71) Applicant: SONY GROUP CORPORATION, TOKYO (JP)

(72) Inventor: ATSUSHI ITO, TOKYO (JP)

(21) Appl. No.: 18/258,206

(22) PCT Filed: Nov. 17, 2021
(86) PCT No.: PCT/JP2021/042182

§ 371 Date: Jun. 17, 2023

(30) Foreign Application Priority Data
Dec. 25, 2020 (JP) 2020-216115

(51) Int. Cl. G02B 5/18; G02B 5/28

(52) U.S. Cl. CPC G02B 5/18; G02B 5/28; G02B 2005/1804

(57) ABSTRACT

There is provided an optical member and an optical apparatus capable of miniaturizing a device while illuminance on a multilayer film is uniform. The present technology provides an optical member including an angle selection film that transmits light incident at a predetermined angle among incident light, and a diffraction grating that diffracts the incident light and emits the light to the angle selection film, in which the diffraction grating and the angle selection film are disposed in an order of the diffraction grating and the angle selection film from an incident side of the light. Furthermore, the present technology also provides an optical apparatus including the optical member, a wavelength selector that transmits light of a predetermined wavelength among light transmitted by the optical member, and a light receiver that receives light transmitted by the wavelength selector, in which the optical member, the wavelength selector, and the light receiver are disposed in an order of the optical member, the wavelength selector, and the light receiver from the incident side of the light.

### TECHNICAL FIELD

The present technology relates to an optical member and an optical apparatus.

### BACKGROUND ART

Conventionally, there has been used a technology of irradiating a non-measurement target with predetermined light and measuring transmittance, reflectance, and the like of the light to analyze a composition of the non-measurement target. In order to use this technology, a spectrometer that resolves light into predetermined wavelengths is employed. In order to improve convenience of the spectrometer, for example, improvements as disclosed in Patent Documents 1 and 2 and the like have been made.

However, such a spectrometer has a characteristic that an accurate wavelength cannot be measured because the spectrometer behaves as if the wavelength becomes longer when a light receiving surface is obliquely irradiated with light.

Therefore, a technology of projecting light in a normal direction with respect to the light receiving surface is used. Examples of this technology include a technology in which light passing through a slit is made parallel by a concave mirror and a technology in which light passing through a pinhole is made parallel by a lens.

However, in a technology using a slit, a pinhole, or the like, utilization efficiency of light is low, and in addition, a distance from the slit to the concave mirror or a distance from the pinhole to the lens is required, and thus there is a problem that it is difficult to miniaturize the spectrometer.

In order to solve this problem, for example, Patent Document 3 and the like disclose a technology of selecting an angle of light by using a multilayer film. This multilayer film is designed to transmit only p-polarized light incident at a Brewster's angle. Furthermore, for example, Patent Document 4 and the like disclose a technology in which a prism is disposed on both surfaces of a multilayer film to refract an optical axis in order to allow light to enter the multilayer film at a Brewster's angle. It is therefore possible to further miniaturize the spectrometer as compared with an embodiment using a lens.

### CITATION LIST

### Patent Document

Patent Document 1: Japanese Patent Application National Publication (Laid-Open) No. 2008-521011

Patent Document 2: Japanese Patent Application National Publication (Laid-Open) No. H10-512678

Patent Document 3: US Patent Application Publication No. 2016/0252652 Specification

Patent Document 4: Japanese Patent Application Laid-Open No. H03-157621

### SUMMARY OF THE INVENTION

### Problems to be Solved by the Invention

However, the inventor (s) has found a problem that the illuminance on the multilayer film is not uniform (unevenness of illuminance occurs) because the angles of the light emitted by the prisms are not uniform.

Therefore, a main object of the present technology is to provide an optical member and an optical apparatus capable of miniaturizing a device while illuminance on a multilayer film is uniform.

### Solutions to Problems

The present technology provides an optical member including an angle selection film that transmits light incident at a predetermined angle among incident light, and a diffraction grating that diffracts the incident light and emits the light to the angle selection film, in which the diffraction grating and the angle selection film are disposed in an order of the diffraction grating and the angle selection film from an incident side of the light.

The optical member may further include a second diffraction grating that diffracts and emits the light transmitted by the angle selection film when the diffraction grating includes a first diffraction grating, in which the first diffraction grating, the angle selection film, and the second diffraction grating are disposed in an order of the first diffraction grating, the angle selection film, and the second diffraction grating from the incident side of the light.

Each of the first diffraction grating and the second diffraction grating has a bilaterally symmetrical shape in a side view.

The angle selection film may include at least two or more layers of a first member and a second member that are alternately stacked, and the first member may have a refractive index larger than a refractive index of the second member.

The first member may include germanium, and the second member may include zinc sulfide.

The diffraction grating may be uniformly provided with a plurality of grooves having a same shape.

Each of the grooves may have a shape including two sides of an equal length and one apex angle in a side view.

The apex angle may have an angle of 50 degrees to 100 degrees in a side view.

The diffraction grating may have an interval smaller than a wavelength of the light emitted from the diffraction grating.

The diffraction grating may include germanium.

Furthermore, the present technology also provides an optical apparatus including the optical member, a wavelength selector that transmits light of a predetermined wavelength among light transmitted by the optical member, and a light receiver that receives light transmitted by the wavelength selector, in which the optical member, the wavelength selector, and the light receiver are disposed in an order of the optical member, the wavelength selector, and the light receiver from the incident side of the light.

The light receiver may include a plurality of light receiving elements arranged in an array, the wavelength selector may have a plurality of regions respectively corresponding to the plurality of light receiving elements, and each of the plurality of regions may transmit light having a different wavelength.

The wavelength selector may correct the wavelength in accordance with the angle of the light incident on the wavelength selector.

The wavelength selector may have at least two high reflectance surfaces, and the wavelength selector may change a distance between the two high reflectance surfaces in accordance with an angle of light incident on the wavelength selector.

### BRIEF DESCRIPTION OF DRAWINGS

FIG. 1 is a schematic side view illustrating a configuration of an optical member 10 according to a first embodiment of the present technology.

FIG. 2 is a schematic side view illustrating a shape of a part of a diffraction grating 12a according to an embodiment of the present technology.

FIG. 3 is a graph illustrating a simulation result of characteristics of the diffraction grating 12a according to an embodiment of the present technology.

FIG. 4 is a schematic side view illustrating a configuration of the optical member 10 according to a second embodiment of the present technology.

FIG. 5 is a graph illustrating a simulation result of characteristics of a second diffraction grating 12b according to an embodiment of the present technology.

FIG. 6 is a schematic side view illustrating a configuration of an optical apparatus 100 according to a third embodiment of the present technology.

FIG. 7 is a graph illustrating a simulation result of characteristics of a diffraction grating according to an embodiment of the present technology.

FIG. 8 is a schematic diagram illustrating a function of a wavelength selector 20 according to an embodiment of the present technology.

FIG. 9 is a schematic side view illustrating a configuration of the optical apparatus 100 according to a fourth embodiment of the present technology.

FIG. 10 is a schematic side view illustrating a configuration of a comparative example of the present technology.

FIG. 11 is a schematic side view illustrating a configuration of a comparative example of the present technology.

FIG. 12 is a schematic side view illustrating a configuration of a comparative example of the present technology.

FIG. 13 is a schematic side view illustrating a configuration of a comparative example of the present technology.

FIG. 14 is a diagram illustrating a simulation result according to a comparative example of the present technology.

FIG. 15 is a schematic side view illustrating a part of configurations of a comparative example and an implementation example of the present technology.

### MODE FOR CARRYING OUT THE INVENTION

Hereinafter, preferred embodiments for implementing the present technology will be described. The embodiments described below illustrate an example of a representative embodiment of the present technology, and the scope of the present technology is not narrowly interpreted by the example. Furthermore, each view is a schematic diagram, and is not necessarily strictly shown.

In the drawings, unless otherwise specified, “upper” means upward or an upper side in the drawings, “lower” means downward or a lower side in the drawings, “left” means leftward or a left side in the drawings, and “right” means rightward or a right side in the drawings. Furthermore, in the drawings, the same or equivalent elements or members are designated by the same reference signs, and redundant description will be omitted.

The present technology will be described in the following order.

1. First embodiment of present technology (Example 1 of optical member)

(1) Overview

(2) Description of first embodiment

(3) Diffraction grating

(4) Angle selection film

2. Second embodiment of present technology (Example 2 of optical member)

3. Third embodiment of present technology (Example 1 of optical apparatus)

4. Fourth embodiment of present technology (Example 2 of optical apparatus)

### 1. First Embodiment of Present Technology (Example 1 of Optical Member)

### (1) Overview

Conventionally, there has been used a technology of irradiating a non-measurement target with predetermined light and measuring transmittance, reflectance, and the like of the light to analyze a composition of the non-measurement target.

In order to use this technology, a spectrometer that resolves light into predetermined wavelengths is employed. The spectrometer includes a light receiver that receives light to obtain characteristics of the light. However, such a spectrometer has a characteristic that an accurate wavelength cannot be measured because the spectrometer behaves as if the wavelength becomes longer when a light receiving surface is obliquely irradiated with light.

Therefore, a technology of projecting light in a normal direction with respect to the light receiving surface is used. An example of this technology will be described with reference to FIG. 10. FIG. 10 is a schematic side view illustrating a configuration of a comparative example of the present technology. As illustrated in FIG. 10, this device includes a light source 91, a pinhole 92, a lens 93, a wavelength selector 94, and a light receiver 95. Light emitted from the light source 91 passes through the pinhole 92, is made parallel by the lens 93, passes through the wavelength selector 94, and enters the light receiver 95.

However, in a technology using a slit, a pinhole, or the like, utilization efficiency of light is low, and in addition, a distance from the slit to the concave mirror or a distance from the pinhole to the lens is required, and thus there is a problem that it is difficult to miniaturize the spectrometer.

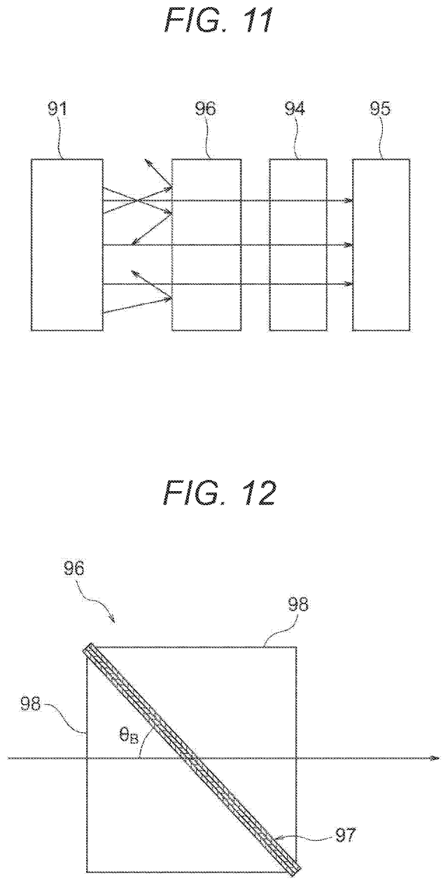

In order to solve this problem, for example, Patent Document 3 and the like disclose a technology of selecting an angle of light by using a multilayer film. This technology will be described with reference to FIG. 11. FIG. 11 is a schematic side view illustrating a configuration of a comparative example of the present technology. As illustrated in FIG. 11, this device includes the light source 91, an angle selector 96, the wavelength selector 94, and the light receiver 95. The light emitted from the light source 91 passes through the angle selector 96 to be parallel, passes through the wavelength selector 94, and enters the light receiver 95.

The angle selector 96 includes a multilayer film (not shown). This multilayer film is designed to transmit only p-polarized light incident at a Brewster's angle.

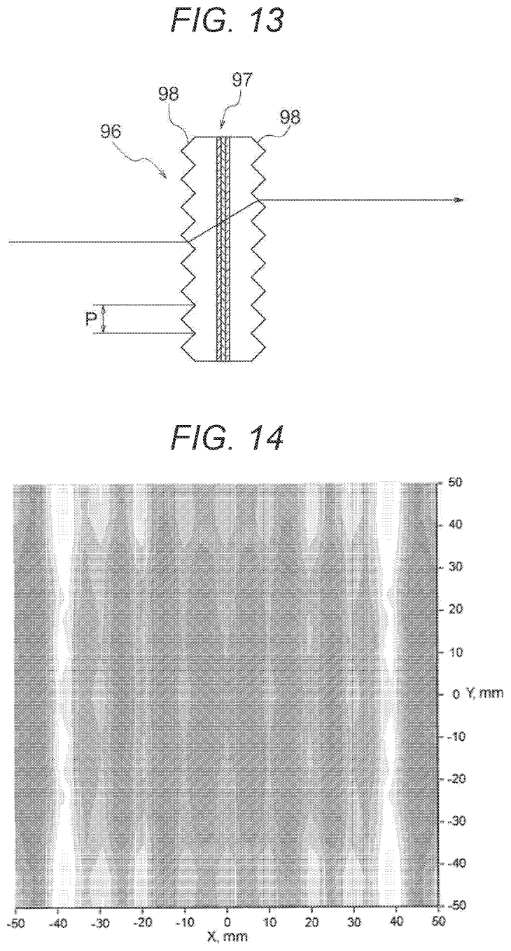

Furthermore, for example, Patent Document 4 and the like disclose a technology in which prisms are disposed on both surfaces of the multilayer film to refract an optical axis in order to allow the light to enter the multilayer film at the Brewster's angle. This technology will be described with reference to FIGS. 12 and 13. FIGS. 12 and 13 are schematic side views each illustrating a configuration of a comparative example of the present technology.

In the configuration illustrated in FIG. 12, prisms 98 are each disposed on a light incident side and a light emitting side of a multilayer film 97 inclined at a Brewster's angle θ_{B}. This configuration is generally used as a polarization beam splitter. This configuration requires a large space for disposing the prisms 98 on the optical axis, and thus is not suitable for miniaturizing the device.

On the other hand, in the configuration illustrated in FIG. 13, a plurality of grooves having the same shape is formed in the prisms 98 each disposed on the light incident side and the light emitting side. The grooves refract the optical axis. Since this configuration has a small space on the optical axis, it is suitable for miniaturizing the device.

However, the inventor(s) has found a problem that the illuminance on the multilayer film is not uniform because the angles of the light emitted by the prisms are not uniform. This problem will be described with reference to FIG. 14. FIG. 14 is a diagram illustrating a simulation result according to a comparative example of the present technology. As illustrated in FIG. 14, light and dark stripes are generated corresponding to the unevenness extending in the up-down direction in the drawing.

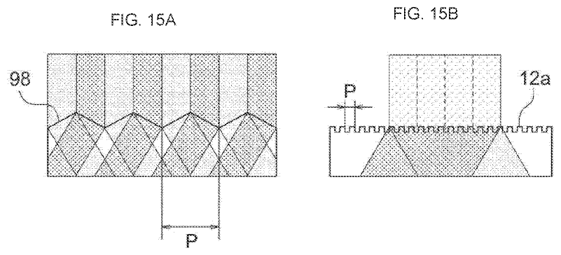

The prism changes the angle of the emitted light in accordance with the wavelength of the incident light and the angle of the surface on which the light is incident. This configuration will be described with reference to FIG. 15. FIG. 15 is a schematic side view illustrating a part of configurations of a comparative example and an implementation example of the present technology. FIG. 15A is a schematic side view illustrating a part of a configuration of the prism 98 as a comparative example of the present technology. FIG. 15B is a schematic side view illustrating a part of a configuration of the diffraction grating 12a as an implementation example of the present technology.

As illustrated in FIG. 15A, the grooves formed in the prism 98 are aligned in parallel at predetermined intervals P. The grooves have a uniform shape, but the intervals P are large. Therefore, for example, the light incident on the surface inclined in the upper right direction is refracted by the prism 98 and emitted in the lower right direction. In a similar manner, the light incident on the surface inclined in the lower right direction is refracted by the prism 98 and emitted in the lower left direction. As a result, the emitted lights overlap each other to generate unevenness of illuminance as illustrated in FIG. 14. A pitch, a modulation degree, and the like of the stripes greatly depend on the design of the prism, but the above problem occurs as long as the prism is provided.

As illustrated in FIG. 15B, the grooves formed in the diffraction grating 12a are aligned in parallel at predetermined intervals P. The grooves have a uniform shape, and the intervals P are significantly small. Therefore, the incident light is diffracted by the diffraction grating 12a and uniformly emitted in the lower right direction or the lower left direction. Therefore, the occurrence of unevenness of illuminance is prevented.

### (2) Description of First Embodiment

An optical member according to an embodiment of the present technology is mainly used to make the optical axis incident on the optical member parallel. The optical member can be used for a spectrometer requiring parallel light, but is not limited to this spectrometer. The optical member can be used for various devices requiring parallel light, such as a display, for example.

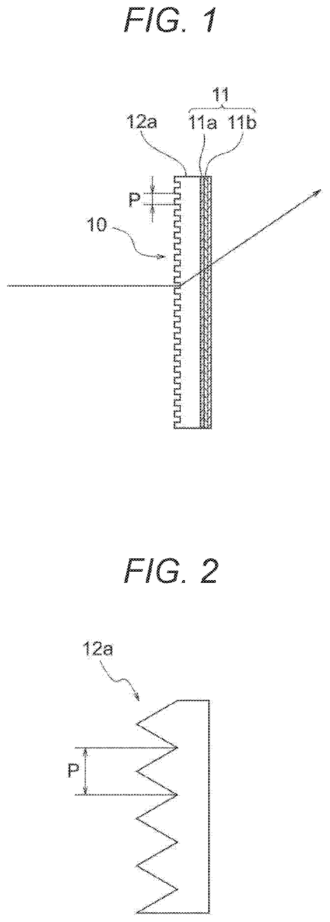

A configuration of an optical member according to a first embodiment of the present technology will be described with reference to FIG. 1. FIG. 1 is a schematic side view illustrating a configuration of an optical member 10 according to the first embodiment of the present technology. As illustrated in FIG. 1, the optical member 10 according to the first embodiment of the present technology includes an angle selection film 11 that transmits light incident at a predetermined angle among incident light, and a diffraction grating 12a that diffracts the incident light and emits the light to the angle selection film 11. The diffraction grating 12a and the angle selection film 11 are disposed in this order from a light incident side. The diffraction grating 12a and the angle selection film 11 are disposed to be optically bonded to each other. The optical bonding means that refractive indexes of portions in contact with the diffraction grating 12a and the angle selection film 11 are the same.

Such a configuration allows the optical member 10 to transmit only light incident at a predetermined angle, and thus emit parallel light. Furthermore, grooves formed in the diffraction grating 12a are aligned in parallel at predetermined intervals. The grooves have a uniform shape, and the intervals P of the diffraction grating are significantly small. Therefore, the angle of the light incident on the angle selection film 11 is also uniform. As a result, the illuminance on the angle selection film 11 becomes uniform, and occurrence of unevenness of illuminance can be prevented. In addition, since a large space such as a prism is unnecessary, the device can be miniaturized. Note that these effects similarly occur in other embodiments described later. Therefore, a repeated description of the effects is occasionally omitted.

### (3) Diffraction Grating

In the diffraction grating 12a, a plurality of grooves (grating patterns) having the same shape is uniformly formed. As illustrated in FIG. 1, the grooves may have a linear uneven shape in a side view.

The grooves are aligned in parallel at predetermined intervals. The grooves have a uniform shape, and the intervals P of the diffraction grating are significantly small. As a result, even without directivity in the light incident on the optical member 10, the illuminance on the angle selection film 11 becomes uniform, and the occurrence of unevenness of illuminance can be prevented.

Alternatively, the shape of the grooves may be a shape as illustrated in FIG. 2. FIG. 2 is a schematic side view illustrating a shape of a part of the diffraction grating 12a according to an embodiment of the present technology. As illustrated in FIG. 2, each of the grooves has a shape including two sides of an equal length and one apex angle in a side view. As a result, the efficiency of a first order diffracted light emitted from the diffraction grating 12a is improved.

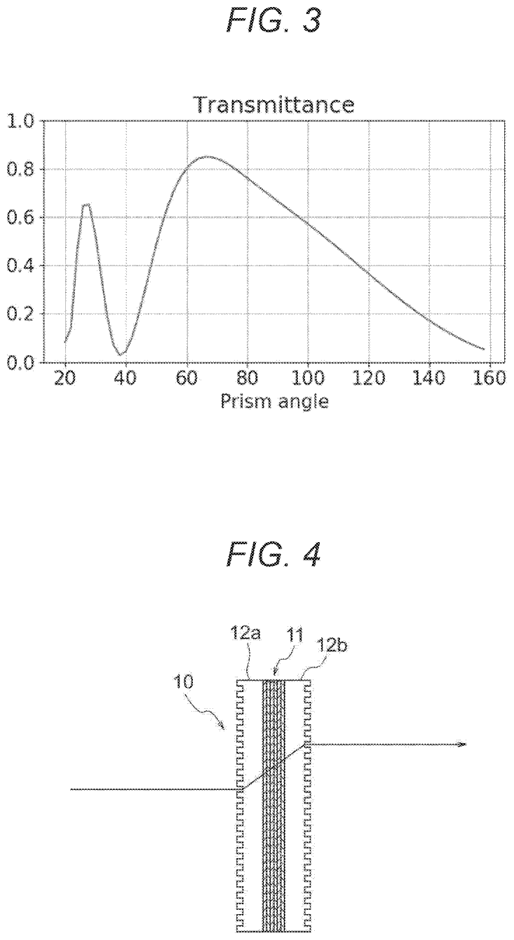

This configuration will be described with reference to FIG. 3. FIG. 3 is a graph illustrating a simulation result of characteristics of the diffraction grating 12a according to an embodiment of the present technology. In FIG. 3, the horizontal axis represents the angle of the apex angle, and the vertical axis represents the efficiency of the first order diffracted light. The diffraction grating 12a includes germanium (Ge).

As shown in the simulation result, when the angle of the apex angle is 50 degrees to 100 degrees in a side view, the efficiency of the first order diffracted light is high. When the angle of the apex angle is 55 degrees to 90 degrees in the side view, the efficiency of the first order diffracted light is higher, which is more preferable. When the angle of the apex angle is 60 degrees to 80 degrees in the side view, the efficiency of the first order diffracted light is even higher, which is further more preferable.

Note that it goes without saying that the shape of the grooves is not limited to the shape described above. The diffraction grating 12a may be, for example, a blazed diffraction grating. When the angle selection film 11 is designed to transmit light incident at a Brewster's angle, it is desirable that the diffraction grating 12a has the highest diffraction efficiency to the Brewster's angle. For example, when the refractive index of the diffraction grating is 2.5 and the refractive index of the angle selection film 11 is 1.6, a blazed diffraction grating having an apex angle of 78.7 degrees is preferable. Alternatively, a corresponding metasurface may be used.

### (4) Angle Selection Film

FIG. 1 will be described again. The angle selection film 11 is a multilayer film in which at least two or more layers of a first member 11a and a second member 11b are alternately laminated. The refractive index of the first member 11a is larger than the refractive index of the second member 11b. This configuration allows the optical member 10 to transmit only light incident at a predetermined angle.

Since only light incident at a predetermined angle is required to be transmitted, a material constituting the first member 11a and the second member 11b is not limited. An example of this material will be described below. For example, the first member 11a may include germanium (Ge), and the second member 11b may include zinc sulfide (ZnS). Germanium has a refractive index larger than a refractive index of zinc sulfide.

By alternately stacking about 30 to 50 layers of the first member 11a including germanium and the second member 11b including zinc sulfide, the angle selection film 11 can transmit only p-polarized light incident at the Brewster's angle and having a wavelength of 5 μm to 10 μm. The more layers stacked, the closer the Brewster's angle is to 29.5 degrees and the wider the range of wavelengths of transmission.

When the Brewster's angle is 29.5 degrees, the deflection angle of the first order diffracted light emitted from the diffraction grating 12a is also preferably 29.5 degrees. For example, in a case where the diffraction grating 12a is designed to be optimized for light having a wavelength of 9 μm and includes germanium, the deflection angle can be set to 29.5 degrees by setting a pitch P between the grooves of the diffraction grating 12a (the intervals of the diffraction grating) to 4.7 μm.

In addition, since the diffraction grating 12a includes germanium, when the structure of the diffraction grating 12a is, for example, as described above, second order diffracted light is less likely to occur. In a case where the diffraction grating 12a includes, for example, silicon or the like, second order diffracted light occasionally occurs even if the structure of the diffraction grating 12a is as described above. This second order diffracted light can be noise in analysis.

Furthermore, since each of the intervals P of the diffraction grating is 4.7 μm and the wavelength of a transmission target is 9 μm, each of the intervals P of the diffraction grating is smaller than the wavelength of the light emitted by the diffraction grating. It is therefore possible to prevent unevenness of illuminance from occurring on the angle selection film 11.

The above design allows the optical member 10 to transmit light having a wavelength of about 9 μm. By using light having a wavelength of about 9 μm, for example, organic composition analysis using light absorption by a carbon-oxygen bond can be performed.

Note that the wavelength of light transmitted by the optical member 10 is not limited to about 9 μm described above. The optical member 10 may be designed to transmit visible light. For example, by using tantalum pentoxide (Ta2O5) or the like instead of germanium and using silicon dioxide (SiO2) or the like instead of zinc sulfide, the optical member 10 can transmit visible light.

However, the longer the wavelength of transmitted light, the greater the effect of the present technology. Referring again to the comparative example illustrated in FIG. 10, for example, in order to make visible light passing through the pinhole 92 having a diameter of 1 mm parallel, the diameter of the lens 93 needs to be about 10 mm. On the other hand, in order to make light having a wavelength of 9 μm passing through the same pinhole 92 parallel, the diameter of the lens 93 needs to be about 100 mm. When light having a wavelength of 9 μm is made parallel light, the light has a longer wavelength than visible light, and thus the device tends to be larger. Therefore, by using the present technology, the longer the wavelength of transmitted light, the more miniaturized the device can be.

Note that the angle of the light incident on the angle selection film 11 is not required to be a Brewster's angle, and the light transmitted by the angle selection film 11 is not required to be p-polarized light. The angle selection film 11 may include one kind of member or may include three or more kinds of members.

### 2. Second Embodiment of Present Technology (Example 2 of Optical Member)

A configuration of an optical member according to a second embodiment of the present technology will be described with reference to FIG. 4. FIG. 4 is a schematic side view illustrating a configuration of an optical member 10 according to the second embodiment of the present technology. As illustrated in FIG. 4, when the diffraction grating 12a is a first diffraction grating 12a, the optical member 10 according to the second embodiment of the present technology further includes a second diffraction grating 12b that diffracts and emits light transmitted by the angle selection film 11. The first diffraction grating 12a, the angle selection film 11, and the second diffraction grating 12b are disposed in this order from the incident side of the light. The first diffraction grating 12a and the angle selection film 11 are disposed to be optically bonded to each other. The angle selection film 11 and the second diffraction grating 12b are disposed to be optically bonded to each other.

Such a configuration allows the optical member 10 to transmit only light incident at a predetermined angle, and thus emit parallel light. Grooves formed in the first diffraction grating 12a are aligned in parallel at predetermined intervals. The grooves have a uniform shape, and the intervals P of the diffraction grating are significantly small. Therefore, the angle of the light incident on the angle selection film 11 is also uniform. As a result, the illuminance on the angle selection film 11 becomes uniform, and occurrence of unevenness of illuminance can be prevented. Furthermore, since the second diffraction grating 12b has a similar structure to the first diffraction grating 12a, the second diffraction grating 12b can emit parallel light having uniform illuminance.

In a similar manner to the first diffraction grating 12a, the shape of the plurality of grooves formed in the second diffraction grating 12b may be a linear uneven shape in a side view.

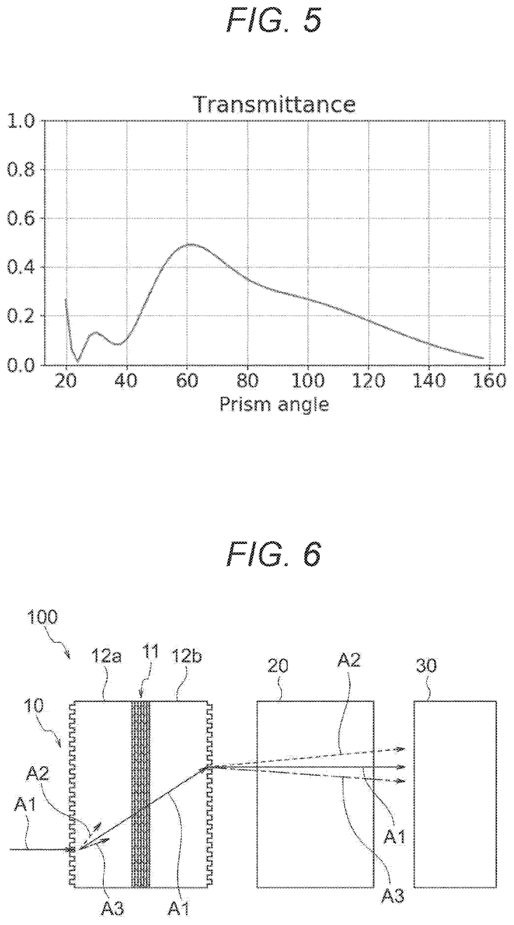

Alternatively, as illustrated in FIG. 2, each of the grooves may have a shape including two sides of an equal length and one apex angle in a side view. The apex angle will be described with reference to FIG. 5. FIG. 5 is a graph illustrating a simulation result of characteristics of the second diffraction grating 12b according to an embodiment of the present technology. In FIG. 5, the horizontal axis represents the angle of the apex angle, and the vertical axis represents the efficiency of the first order diffracted light. The second diffraction grating 12b includes germanium (Ge).

As shown in the simulation result, when the angle of the apex angle is 50 degrees to 100 degrees in a side view, the efficiency of the first order diffracted light is high. When the angle of the apex angle is 55 degrees to 70 degrees in the side view, the efficiency of the first order diffracted light is higher, which is more preferable. When the angle of the apex angle is about 60 degrees in the side view, the efficiency of the first order diffracted light is even higher, which is further more preferable.

The first diffraction grating 12a and the second diffraction grating 12b are each preferably formed in a bilaterally symmetrical shape in a side view. Thus, each of the first diffraction grating 12a and the second diffraction grating 12b can be manufactured in the same process. As a result, there is an effect that the manufacturing cost is reduced.

### 3. Third Embodiment of Present Technology (Example 1 of Optical Apparatus)

A configuration of an optical apparatus according to a third embodiment of the present technology will be described with reference to FIG. 6. FIG. 6 is a schematic side view illustrating a configuration of an optical apparatus 100 according to the third embodiment of the present technology. As illustrated in FIG. 6, the optical apparatus 100 according to the third embodiment of the present technology includes an optical member 10, a wavelength selector 20 that transmits light of a predetermined wavelength among light transmitted by the optical member 10, and a light receiver 30 that receives the light transmitted by the wavelength selector 20. The optical member 10, the wavelength selector 20, and the light receiver 30 are disposed in this order from the incident side of the light.

The wavelength selector 20 transmits only light incident at a predetermined wavelength. The information regarding the predetermined wavelength can be stored in, for example, a storage (not shown) or the like included in the optical apparatus 100. The wavelength selector 20 can be achieved by using, for example, an existing band pass filter having a fixed wavelength. Specifically, the wavelength selector 20 can be achieved by using, for example, a dielectric multilayer film, a waveguide mode resonance filter, or the like.

Alternatively, the information regarding the predetermined wavelength may be input from outside of the optical apparatus 100. As a result, the wavelength of the light transmitted by the wavelength selector 20 can be changed. The wavelength selector 20 can be achieved by using, for example, an existing band pass filter having a changeable wavelength. Specifically, the wavelength selector 20 can be achieved by using, for example, a Michelson interferometer, a Fabry-Perot interferometer, a liquid crystal tunable filter, an acoustic tunable filter, or the like.

The light receiver 30 receives the light transmitted by the wavelength selector 20. In a case of receiving light having a wavelength of about 9 μm, the light receiver 30 can be achieved by using, for example, a bolometer, a HgCdTe sensor, a pyroelectric sensor, a thermopile, or the like. Alternatively, in a case of receiving visible light or near-infrared light, the light receiver 30 can be achieved by using, for example, a Si photodiode, a GaAs photodiode, or the like.

Since the light receiver 30 is provided, a calculator (not shown) included in the optical apparatus 100 can analyze characteristics of received light, for example. Specifically, the optical apparatus 100 can perform, for example, organic composition analysis and the like. Therefore, the wavelength of light incident on the light receiver 30 is preferably 2 μm to 10 μm, and more preferably 8 μm to 10 μm.

Incidentally, the diffraction grating has a characteristic that an emission angle of light varies depending on a wavelength. This characteristic will be described. When an optical axis A1 is incident on the first diffraction grating 12a, the diffracted light is occasionally emitted in a direction slightly deviated from the target, such as a direction of an optical axis A2 or an optical axis A3, for example. The wavelength of the optical axis A1 is a wavelength mainly analyzed by the optical apparatus 100. The wavelengths of the optical axis A2 and the optical axis A3 are slightly different from the wavelength of the optical axis A1. Therefore, the emission angles of the optical axis A2 and the optical axis A3 are slightly different from the emission angle of the optical axis A1.

However, since the angle selection film 11 transmits only light incident at a predetermined angle, the optical axis A2 and the optical axis A3 having a wavelength slightly different from the wavelength to be mainly analyzed do not transmit through the angle selection film 11. Therefore, no problem occurs in the first diffraction grating 12a.

On the other hand, a problem occurs in the second diffraction grating 12b. When the optical axis Al is incident on the second diffraction grating 12b, the diffracted light is occasionally emitted in a direction slightly deviated from the target, such as the direction of the optical axis A2 or the optical axis A3, for example. The optical axis A1 to be analyzed is incident on the wavelength selector 20 in the normal direction, but the optical axis A2, the optical axis A3, and the like slightly deviated from the target are incident on the wavelength selector 20 in a slightly oblique direction.

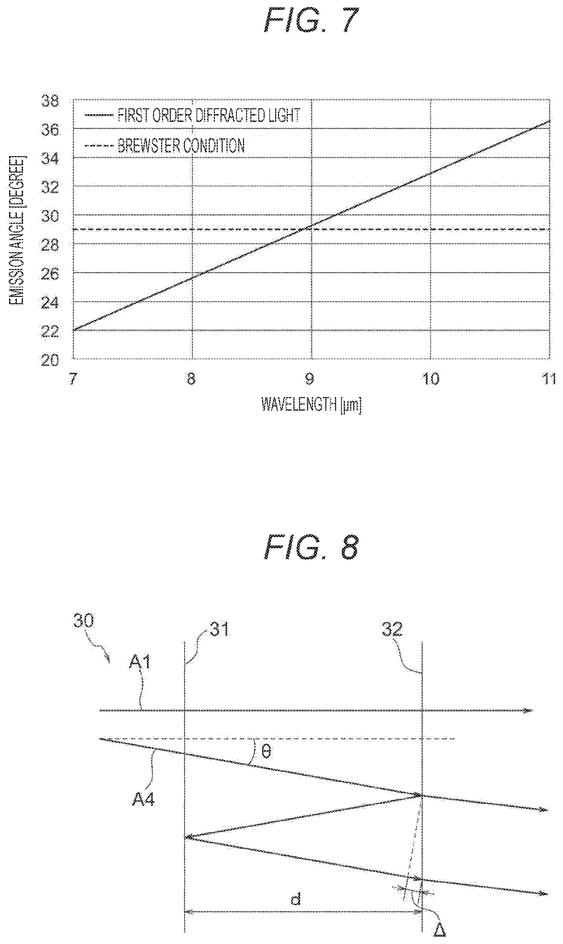

This problem will be further described with reference to FIG. 7. FIG. 7 is a graph illustrating a simulation result of characteristics of the diffraction grating according to an embodiment of the present technology. In FIG. 7, the horizontal axis represents the wavelength of light incident on the diffraction grating, and the vertical axis represents the emission angle of the first order diffracted light. This diffraction grating includes germanium (Ge).

As illustrated in the simulation result, the diffraction grating is designed to emit light at an emission angle of 29.5 degrees, for example, when light having a wavelength of 9 μm to be mainly analyzed is incident. Therefore, the light emitted from the diffraction grating can be incident on the wavelength selector 20 in the normal direction.

However, for example, when light having a wavelength of 7 μm is incident on the diffraction grating, the diffraction grating is emitted at an emission angle of 22 degrees. Therefore, the light emitted from the diffraction grating is incident on the wavelength selector 20 with inclination of 7.5 degrees (a difference between 29.5 degrees and 22 degrees) with respect to the normal direction. Such an inclination of the angle may cause a decrease in wavelength resolution accuracy of the wavelength selector 20.

Therefore, the wavelength selector 20 may correct the wavelength in accordance with the angle of the light incident on the wavelength selector 20. That is, the wavelength selector 20 may correct the wavelength on the assumption that the light is incident with an inclined angle. As a result, the wavelength selector 20 can compensate for the characteristic of the diffraction grating that the emission angle of light varies depending on the wavelength.

This configuration will be described with reference to FIG. 8. FIG. 8 is a schematic diagram illustrating a function of the wavelength selector 20 according to an embodiment of the present technology. As illustrated in FIG. 8, the wavelength selector 20 includes at least two high reflectance surfaces 31 and 32. Each of the two high reflectance surfaces 31 and 32 is a planar optical element having high reflectance, and is disposed to face each other.

For example, the Fabry-Perot interferometer has this configuration. The Fabry-Perot interferometer is a device that multiply reflects light between the two high reflectance surfaces 31 and 32 and measures a wavelength, a phase difference, and the like by using interference of passing light. If a distance d between the two high reflectance surfaces 31 and 32 is appropriate, interference occurs between the original light and the multiply reflected light. Specifically, when the distance d between the two high reflectance surfaces 31 and 32 becomes an integral multiple of the wavelength, the light interferes and passes. As a result, the Fabry-Perot interferometer can measure a wavelength, a phase difference, and the like of light.

The optical axis A1 having the wavelength to be mainly analyzed is incident on the wavelength selector 20 in the normal direction. However, an optical axis A4 having a wavelength that is not the wavelength described above is incident on the wavelength selector 20 at an incident angle θ inclined from the normal direction.

When the incident angle on the wavelength selector 20 is inclined by θ, an optical axis difference Δ until reaching the light receiver 30 can be calculated, for example, in accordance with the following equation (1) or the like by using the distance d between the two high reflectance surfaces 31 and 32.

$$Δ = 2 d •sinθ•tanθ \qquad ( 1 )$$

The optical axis A1 having the wavelength to be optimized interferes at the distance d. However, the optical axis A4 whose incident angle is inclined by θ interferes at a distance extended by the optical axis difference Δ. Therefore, the optical apparatus 100 cannot accurately measure the wavelength, phase difference, and the like of this light.

Therefore, the wavelength selector 20 can change the distance d between the two high reflectance surfaces 31 and 32 in accordance with the angle of the light incident on the wavelength selector 20. Specifically, the distance d between the two high reflectance surfaces 31 and 32 can be changed in accordance with the optical axis difference Δ. Alternatively, the optical apparatus 100 may correct the measured wavelength.

For example, a case is assumed where light of 10 μm is incident on the light receiver 30 optimized for light of a wavelength of 9 μm. Referring to FIG. 7, when the light having a wavelength of 10 μm is incident on the diffraction grating, the diffraction grating is emitted at an emission angle of 33 degrees. Therefore, the light emitted from the diffraction grating is incident on the wavelength selector 20 with inclination of 3.5 degrees (a difference between 29.5 degrees and 33 degrees) with respect to the normal direction.

When applied to the above equation (1), the distance d is equivalent to being extended by about 0.4%. Therefore, by changing the distance d by the wavelength selector 20, the optical apparatus 100 can accurately measure the wavelength, the phase difference, and the like of the light.

Note that the angle θ of the light emitted from the diffraction grating may be calculated in accordance with the following equation (2) or the like.

$${n}_{0} sin θ = ( 1 - {λ}_{1} / {λ}_{0} ) {n}_{1} sin {θ}_{B} \qquad ( 2 )$$

In the above equation (2), n₀ is a refractive index in air. n₁ is a refractive index in the diffraction grating. λ₀ is a wavelength in air. λ₁ is a wavelength in the diffraction grating. θ_{B} is a Brewster's angle. The light receiver 30 can be designed to satisfy the above equation (2).

### 4. Fourth Embodiment of Present Technology (Example 2 of Optical Apparatus)

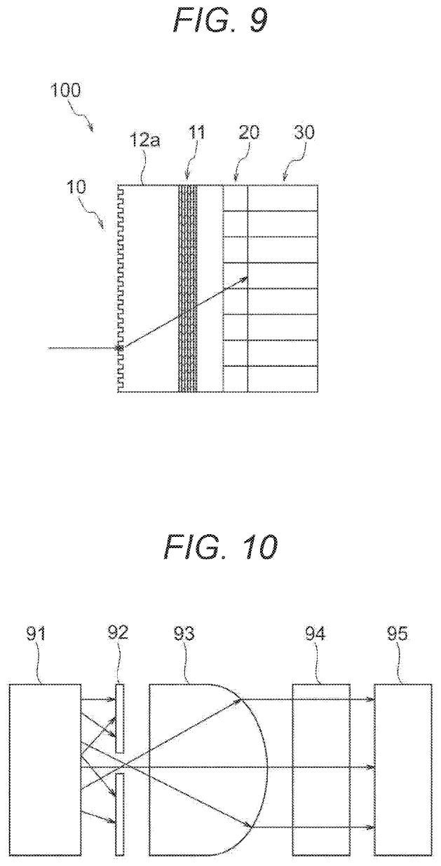

A configuration of an optical apparatus according to a fourth embodiment of the present technology will be described with reference to FIG. 9. FIG. 9 is a schematic side view illustrating a configuration of an optical apparatus 100 according to the fourth embodiment of the present technology. As illustrated in FIG. 9, the optical apparatus 100 according to the fourth embodiment of the present technology includes an optical member 10, a wavelength selector 20 that transmits light of a predetermined wavelength among light transmitted by the optical member 10, and a light receiver 30 that receives the light transmitted by the wavelength selector 20. The optical member 10, the wavelength selector 20, and the light receiver 30 are disposed in this order from the incident side of the light. The optical member 10 and the wavelength selector 20 are optically bonded to each other. The wavelength selector 20 and the light receiver 30 are optically bonded to each other.

The wavelength selector 20 may be designed on the assumption that light is obliquely incident. At this time, there is no need to provide a diffraction grating for allowing light to enter the wavelength selector 20 in the normal direction. It is therefore possible to reduce the size and manufacturing cost of the optical apparatus 100.

The light receiver 30 includes a plurality of light receiving elements arranged in an array. Grooves formed in the diffraction grating 12a are aligned in parallel at predetermined intervals. The grooves have a uniform shape, and the intervals P of the diffraction grating are significantly small. Therefore, the angle of the light incident on the angle selection film 11 is also uniform. Thus, the illuminance on the angle selection film 11 becomes uniform, and occurrence of unevenness of illuminance can be prevented. As a result, it is possible to prevent the occurrence of unevenness of illuminance also in the wavelength selector 20 and the light receiver 30. Therefore, the light receiver 30 can include the plurality of light receiving elements arranged in an array. As an example of the plurality of light receiving elements arranged in an array, an image sensor or the like can be used in a case of receiving visible light. In a case of receiving infrared light, a microbolometer array widely used in thermography or the like can be used.

The wavelength selector 20 has a plurality of regions respectively corresponding to the plurality of light receiving elements. Each of the plurality of regions may transmit light having a different wavelength. As a result, the optical apparatus 100 can analyze light of a plurality of wavelengths by one measurement. Since many analyses can be performed in a short time, analysis efficiency is improved.

Furthermore, since the wavelengths of the light transmitted through the plurality of regions are different from each other, the wavelength is not required to be corrected as described in the third embodiment.

Furthermore, for example, in a case where a guided mode resonant filter is used as the wavelength selector 20, the wavelength selector 20 can be formed simultaneously with the manufacture of the light receiver 30. It is therefore possible to manufacture the optical apparatus 100 small in size at low cost.

In addition, the configurations described in the above embodiments can be selected or changed as appropriate to other configurations without departing from the gist of the present technology.

Note that the effects herein described are merely examples and are not limited, and furthermore, other effects may be obtained.

Note that the present technology may also have following configurations.

[1]

An optical member includes an angle selection film that transmits light incident at a predetermined angle among incident light, and a diffraction grating that diffracts the incident light and emits the light to the angle selection film, in which the diffraction grating and the angle selection film are disposed in an order of the diffraction grating and the angle selection film from an incident side of the light.

[2]

The optical member according to [1] further includes a second diffraction grating that diffracts and emits the light transmitted by the angle selection film when the diffraction grating includes a first diffraction grating, in which the first diffraction grating, the angle selection film, and the second diffraction grating are disposed in an order of the first diffraction grating, the angle selection film, and the second diffraction grating from the incident side of the light.

[3]

In the optical member according to [2], each of the first diffraction grating and the second diffraction grating has a bilaterally symmetrical shape in a side view.

[4]

In the optical member according to any one of [1] to [3], the angle selection film includes at least two or more layers of a first member and a second member that are alternately stacked, and the first member has a refractive index larger than a refractive index of the second member.

[5]

In the optical member according to [4], the first member includes germanium, and the second member includes zinc sulfide.

[6]

In the optical member according to any one of [1] to [5], the diffraction grating is uniformly provided with a plurality of grooves having a same shape.

[7]

In the optical member according to [6], each of the grooves has a shape including two sides of an equal length and one apex angle in a side view.

[8]

In the optical member according to [7], the apex angle has an angle of 50 degrees to 100 degrees in a side view.

[9]

In the optical member according to any one of [1] to [8], the diffraction grating has an interval smaller than a wavelength of the light emitted from the diffraction grating.

[10]

In the optical member according to any one of [1] to [9], the diffraction grating includes germanium.

[11]

An optical apparatus includes the optical member according to any one of [1] to [10], a wavelength selector that transmits light of a predetermined wavelength among light transmitted by the optical member, and a light receiver that receives light transmitted by the wavelength selector, in which the optical member, the wavelength selector, and the light receiver are disposed in an order of the optical member, the wavelength selector, and the light receiver from an incident side of the light.

[12]

In the optical apparatus according to [11], the light receiver includes a plurality of light receiving elements arranged in an array, the wavelength selector has a plurality of regions respectively corresponding to the plurality of light receiving elements, and each of the plurality of regions transmits light having a different wavelength.

[13]

In the optical apparatus according to any one of [10] to [12], the wavelength selector corrects a wavelength in accordance with an angle of light incident on the wavelength selector.

[14]

In the optical apparatus according to any one of [10] to [13], the wavelength selector has at least two high reflectance surfaces, and the wavelength selector changes a distance between the two high reflectance surfaces in accordance with an angle of light incident on the wavelength selector.

### REFERENCE SIGNS LIST

10 Optical member
11 Angle selection film
11a First member
11b Second member
12a Diffraction grating (first diffraction grating)
12b Second diffraction grating
20 Wavelength selector
30 Light receiver
31, 32 High reflectance surface
100 Optical apparatus
P Interval
d Distance

1. An optical member comprising:
an angle selection film that transmits light incident at a predetermined angle among incident light; and
a diffraction grating that diffracts the incident light and emits the light to the angle selection film, wherein
the diffraction grating and the angle selection film are disposed in an order of the diffraction grating and the angle selection film from an incident side of the light.

2. The optical member according to claim 1,
further comprising a second diffraction grating that diffracts and emits the light transmitted by the angle selection film when the diffraction grating includes a first diffraction grating, wherein
the first diffraction grating, the angle selection film, and the second diffraction grating are disposed in an order of the first diffraction grating, the angle selection film, and the second diffraction grating from the incident side of the light.

3. The optical member according to claim 2, wherein each of the first diffraction grating and the second diffraction grating has a bilaterally symmetrical shape in a side view.

4. The optical member according to claim 1, wherein
the angle selection film includes at least two or more layers of a first member and a second member that are alternately stacked, and
the first member has a refractive index larger than a refractive index of the second member.

5. The optical member according to claim 4, wherein
the first member includes germanium, and
the second member includes zinc sulfide.

6. The optical member according to claim 1, wherein the diffraction grating is uniformly provided with a plurality of grooves having a same shape.

7. The optical member according to claim 6, wherein each of the grooves has a shape including two sides of an equal length and one apex angle in a side view.

8. The optical member according to claim 7, wherein the apex angle has an angle of 50 degrees to 100 degrees in a side view.

9. The optical member according to claim 1, wherein the diffraction grating has an interval smaller than a wavelength of the light emitted from the diffraction grating.

10. The optical member according to claim 1, wherein the diffraction grating includes germanium.

11. An optical apparatus comprising:
the optical member according to claim 1;
a wavelength selector that transmits light of a predetermined wavelength among light transmitted by the optical member; and
a light receiver that receives light transmitted by the wavelength selector, wherein
the optical member, the wavelength selector, and the light receiver are disposed in an order of the optical member, the wavelength selector, and the light receiver from an incident side of the light.

12. The optical apparatus according to claim 11, wherein
the light receiver includes a plurality of light receiving elements arranged in an array,
the wavelength selector has a plurality of regions respectively corresponding to the plurality of light receiving elements, and
each of the plurality of regions transmits light having a different wavelength.

13. The optical apparatus according to claim 11, wherein the wavelength selector corrects a wavelength in accordance with an angle of light incident on the wavelength selector.

14. The optical apparatus according to claim 11, wherein
the wavelength selector has at least two high reflectance surfaces, and
the wavelength selector changes a distance between the two high reflectance surfaces in accordance with an angle of light incident on the wavelength selector.
